(19) United States
(12) Patent Application Publication
(10) Pub. No.: US 2019/0085684 A1
(43) Pub. Date: Mar. 21, 2019

(54) METHOD, DEVICE AND TERMINAL FOR DETERMINING BOREHOLE CROSS-SECTIONAL SHAPE

(71) Applicant: SOUTHERN UNIVERSITY OF SCIENCE AND TECHNOLOGY, Shenzhen (CN)

(72) Inventors: Xinding FANG, Shenzhen (CN); Jianxia XU, Shenzhen (CN); Zhentao YANG, Shenzhen (CN)

(21) Appl. No.: 15/970,490

(22) Filed: May 3, 2018

Related U.S. Application Data
(63) Continuation-in-part of application No. 15/773,088.

(30) Foreign Application Priority Data
Sep. 20, 2017 (CN) 201710855148.7

(51) Int. Cl. E21B 47/09; E21B 47/08; G01V 1/52; G06F 17/18; G06F 17/11

(52) U.S. Cl. CPC E21B 47/09; E21B 47/08; G06F 17/11; G06F 17/18; G01V 1/52

(57) ABSTRACT

A method, device, terminal and computer readable storage medium for determining a cross-sectional shape of a borehole involves obtaining a plurality of logging data items as measured at a same depth of a well via a multi-arm caliper. The logging data items include pad coordinates which use a center of the multi-arm caliper as a reference point. Coordinates of a borehole center and a borehole radius at the depth of the well are obtained by using a least squares objective function with a constraint condition and according to the pad coordinates. The constraint condition is that a distance from a pad of a caliper tool to the borehole center is larger than or equal to the borehole radius. The pad positions are located outside a circle or on the circle obtained by fitting according to the least squares objective function, such that a real borehole cross-sectional shape is obtained. Measuring errors of well logging are reduced, and the reliability of the measurement of the borehole cross-sectional shape is improved.

### CROSS REFERENCE TO RELATED APPLICATION

This application is a continuation-in-part of U.S. application Ser. No. 15/773,088, filed May 2, 2018, which is the National Stage of International Application No. PCT/CN2017/111874 filed 20 Nov. 2017, which designated the U.S. and claims priority to CN Application No. 201710855148.7 filed 20 Sep. 2017, the entire contents of each of which are hereby incorporated by reference.

### TECHNICAL FIELD

The present application pertains to the technical field of well logging, and more particularly to a method, a device, a terminal, and computer readable storage medium for determination of a borehole cross-sectional shape.

### BACKGROUND

The technology of well logging is widely used in the field of oil and gas drilling, underground water, mining and geothermal exploration, environment and civil engineering technological research, etc. In the oil and gas drilling, observation data obtained by well logging are very important data for formation lithology determination, stratigraphic interpretation, formation depth and velocity measurement, reservoir characterization, strategic decision of drilling operation, and so on. Wherein, caliper logging is a very important part of well logging. A result of caliper logging can assist in judging lithologic property such as rock type, permeability, fracture characteristics, etc., and can also judge crustal stress condition according to borehole breakouts; meanwhile, the result of caliper logging is also a basis of calibration of borehole effect on petrophysical analyses, and also provides data for analyzing the capability of removing cuttings from a borehole, and for estimating the required quantity of cement in well cementation.

In related art, by calculating an average value of borehole diameters in a borehole cross-section, or based on the intersecting chord theorem of a circle, or performing an ellipse fitting according to a cubic spline function, a circumferential curve of the borehole cross-section can be obtained, and a shape of a borehole can be further obtained. However, the borehole cross-section can have distinct irregularity when keyseats or breakouts exist in the borehole or gas drilling technology is used in drilling. These methods in related art wouldn't be able to measure accurate borehole diameter, and thus can't obtain an accurate shape of the borehole cross-section, resulting in large measuring error.

### Technical Problem

In view of this, an embodiment of the present application provides a borehole cross-sectional shape determination method, device, terminal and computer readable storage medium, which aims at solving a problem that a method for determining borehole cross-sectional shape in related art has a larger measuring error when a borehole cross-section has distinct irregularity.

### Technical Solution

In a first aspect, one embodiment of the present application provides a method for determining borehole cross-sectional shape, comprising:

obtaining a plurality of logging data as measured at the same depth of a borehole via a multi-arm caliper, the logging data includes pad coordinates that take the center of the multi-arm caliper as a reference point;

obtaining borehole center coordinates and a borehole radius at the depth of the well by using a least squares objective function with a constraint condition and according to the coordinates of the pads of a caliper tool; wherein the constraint condition is that a distance from a pad of a caliper tool to the borehole center is larger than or equal to the virgin borehole radius; and

correcting the coordinates of the caliper pads by taking the borehole center as a reference point, and thereby obtaining a borehole cross-sectional shape at the depth of the well.

In a second aspect, one embodiment of the present application provides a device for determining borehole cross-sectional shape, comprising:

an obtaining module configured to obtain a plurality of logging data as measured at the same depth of a borehole via a multi-arm caliper, wherein the logging data include coordinates of each pad of a caliper tool which takes a center of the multi-arm caliper tool as a reference point;

a fitting module configured to obtain borehole center coordinates and a borehole radius at the depth of the well by using a least squares objective function with a constraint condition and according to the wellbore wall coordinates of the pads of a caliper tool; wherein the constraint condition is that a distance from a pad of a caliper tool to the borehole center is larger than or equal to the virgin borehole radius; and

a correcting module configured to correct the coordinates of the pads of a caliper tool by taking the true borehole center as a reference point, and thereby to obtain a borehole cross-sectional shape at the depth of the well.

In a third aspect, one embodiment of the present application provides a measuring device comprising a storage device, a processor and computer program stored in the storage device and executable by the processor, wherein the processor is configured to implement steps in the aforesaid method when executing the computer program.

In a fourth aspect, one embodiment of the present application provides a computer readable storage medium which stores computer program, wherein steps in the aforesaid method are implemented when the computer program is executed by a processor.

### Advantageous Effects

In the embodiment of the present application, by using the least squares objective function with a constraint condition to obtain borehole center coordinates and borehole radius in each depth of a well; wherein, the constraint condition is that a distance from a pad of a caliper tool to the borehole center is larger than or equal to the virgin borehole radius. It is ensured that, the position of each pad of a caliper tool is located outside or on a circle obtained by fitting according to the least squares objective function. However, since a fitting method in related art doesn't have said constraint condition, the position of a pad of a caliper tool may be located within a circle which is obtained by fitting according to a fitting method in related art, such that an error in caliper logging may be resulted. Thus, compared with related art, the embodiment of the present application can obtain the true borehole center coordinates, borehole radius and the borehole cross-sectional shape, reduce a measuring error in caliper logging, and improve a reliability of measurement result of borehole cross-sectional shape.

### BRIEF DESCRIPTION OF THE DRAWINGS

In order to explain the embodiments of the present application more clearly, accompanying figures that need to be used in the embodiments will be described in detail below; it should be understood that, the accompanying drawings described as follows illustrate some embodiments of the present application merely, and thus shouldn't be considered as limitation to the protection scope of the present application; for those skilled in the art, other drawings can also be obtained according to the current drawings at the premise of paying no creative labor.

FIG. 1 illustrates an implementation flow chart of a method for determining borehole cross-sectional shape provided by one embodiment of the present application;

FIG. 2 illustrates a structural schematic view of a multi-arm caliper in a borehole provided by the embodiment of the present application;

FIG. 3 illustrates a schematic view of a comparison between a fitted result of a borehole cross-sectional shape obtained by fitting according to the method for determining borehole cross-sectional shape provided by the embodiment of the present application and a fitted result of a borehole cross-sectional shape obtained by fitting according to a method for determining borehole cross-sectional shape in related art;

FIG. 4 illustrates another schematic view of a comparison between a fitted result of a borehole cross-sectional shape obtained by fitting according to the method for determining borehole cross-sectional shape provided by the embodiment of the present application and a fitted result of a borehole cross-sectional shape obtained by fitting according to a method for determining borehole cross-sectional shape in related art;

FIG. 5 illustrates another implementation flow chart of the method for determining borehole cross-sectional shape provided by the embodiment of the present application;

FIG. 6 illustrates a structural schematic view of a device for determining borehole cross-sectional shape provided by the embodiment of the present application;

FIG. 7 illustrates another structural schematic view of the device for determining borehole cross-sectional shape provided by the embodiment of the present application;

FIG. 8 illustrates one schematic view of a measuring terminal provided by the embodiment of the present application.

### DETAILED DESCRIPTION OF THE PREFERRED EMBODIMENTS

In order to make the purpose, the technical solution and the advantages of the present invention be clearer and more understandable, the present application is further described in detail below with reference to accompanying figures and embodiments. It should be understood that, the embodiments described in detail herein are only intended to explain the present application but not to limit the present application. Meanwhile, in the descriptions of the present application, terms such as “first” and “second”, etc., are only intended to distinguish in description, but shouldn't be interpreted as indicating or implying a relative importance.

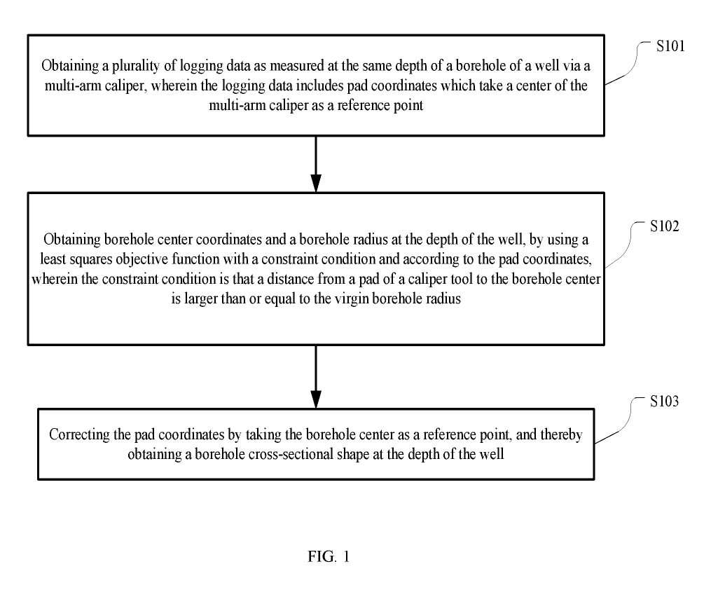

FIG. 1 illustrates an implementation flow chart of a method for determining borehole cross-sectional shape provided by one embodiment of the present application, this method comprises steps from step 101 to step 103.

In the step 101, obtaining a plurality of well logging data of the multi-arm caliper at the same depth of a well; the well logging data includes the coordinates of each pad of the caliper tool which takes the center of the multi-arm caliper as a reference point.

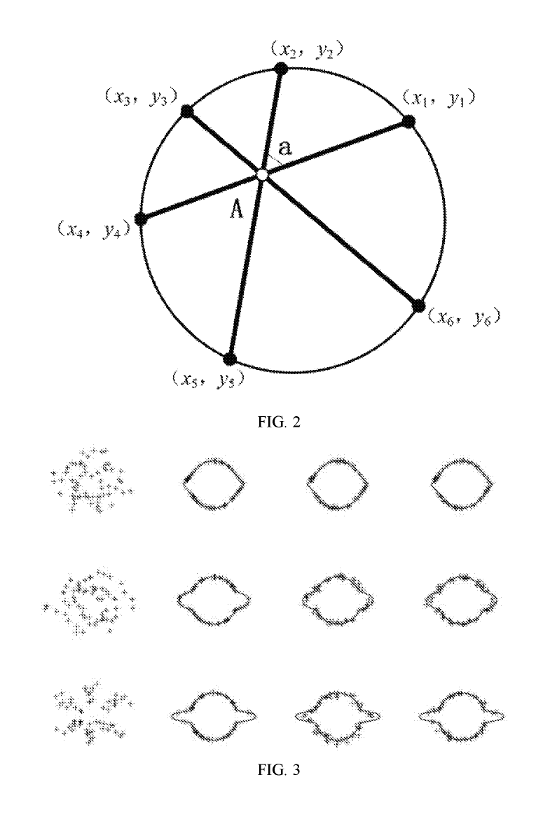

In some embodiments of the present application, the multi-arm caliper gets in touch with the wellbore wall directly by stretching a plurality of measuring arms, and obtains the plurality of well logging data at the same depth of the well according to stretched lengths of the plurality of measuring arms and open angles among the measuring arms. Wherein, the number of the measuring arms of the multi-arm caliper is four, six or other number. As shown in FIG. 2, the embodiment of the present application is described by taking the multi-arm caliper that has six measuring arms for example, when the multi-arm caliper is utilized to obtain the well logging data at many depths of the well, the pad coordinates (xᵢ, yᵢ), which take the center A of the multi-arm caliper as the reference point, are obtained by recording lengths measured by the various measuring arms and included angles among the measuring arms, wherein, i=(1, 2, . . . , N=6), N is the number of the measuring arms. In this embodiment, the included angle a among the measuring arms is 60°.

In step 102, obtaining borehole center coordinates and a borehole radius at the depth of the well by using a least squares objective function with a constraint condition and according to the coordinates of the pads of the caliper tool; wherein the constraint condition is that a distance from a pad of a caliper tool to the borehole center is larger than or equal to the virgin borehole radius.

In some embodiments of the present application, the least squares objective function is a sum of 2-norm of a difference between a square of the distance from the coordinates of a pad to the borehole center coordinates and a square of the borehole radius.

For example, the coordinates of borehole center are (x₀, y₀), the borehole radius is r, the sum of 2-norm of the difference between the square of the distance from the pad coordinates (xᵢ, yᵢ) to the borehole center coordinates (x₀, y₀) and the square of the borehole radius r is

$${\sum }_{i = 1}^{N} {\vert {( {x}_{i} - {x}_{0} )}^{2} + {( {y}_{i} - {y}_{0} )}^{2} - {r}^{2} \vert}^{2} ,$$

that is, the least squares objective function is

$${\sum }_{i = 1}^{N} {\vert {( {x}_{i} - {x}_{0} )}^{2} + {( {y}_{i} - {y}_{0} )}^{2} - {r}^{2} \vert}^{2} .$$

N is the number of caliper arms.

For another example, the constraint condition is that the distance from the pad coordinates (xᵢ, yᵢ) to the borehole center coordinates (x₀, y₀) is larger than or equal to the borehole radius r, that is, the constraint condition is (xᵢ−x₀)²+(yᵢ−y₀)²≥r².

In some embodiments of the present application, the step of using the least squares objective function with the constraint condition to fit the shape of the borehole, and obtaining the borehole center coordinates and the borehole radius at each depth of the well includes: solving, under the constraint of the constraint condition, the borehole center coordinates and the borehole radius when the minimum square objective function takes a minimal value.

It needs to be explained that, since the constraint condition is that the distance from a pad of a caliper tool to the borehole center is larger than or equal to the virgin borehole radius, and since the borehole center coordinates and the borehole radius are solved by the least squares objective function under the constraint of the constraint condition, wherein, more particularly, the borehole center coordinates and the borehole radius are obtained under the constraint of the constraint condition by solving the minimum square objective function when the minimum square objective function takes the minimal value. Thus, it can be ensured that, the positions of all pads are located outside or on a circle obtained by fitting according to the least squares objective function; however, since a fitting method in related art doesn't have said constraint condition, such that the positions of one or more pads can be located within the circle which is obtained by fitting according to the fitting method in related art, thereby resulting in an error in caliper logging, such that an accurate borehole cross-sectional shape can't be measured, and an accurate borehole shape can't be obtained, either.

The embodiment of the present application utilizes the least squares objective function to obtain the borehole center coordinates and the borehole radius at the depth of the well so as to obtain the true borehole cross-sectional shape and obtain the accurate borehole shape, measurement errors of borehole diameter and borehole cross-sectional shape are reduced, and a reliability of measurement results of borehole diameter and borehole cross-sectional shape is improved.

Particularly, a detailed deducing process of solving, under the constraint condition of (xᵢ−x₀)²+(yᵢ−y₀)²≥r², the borehole center coordinates (x₀, y₀) and the borehole radius r

$${\sum }_{i = 1}^{N} {\vert {( {x}_{i} - {x}_{0} )}^{2} + {( {y}_{i} - {y}_{0} )}^{2} - {r}^{2} \vert}^{2}$$

when (N is the number of caliper pads) takes the minimal value is satisfied is described as follows:

firstly, representing the least squares objective function and the constraint condition by a matrix as:

∥A·β−b∥²,

subject to

Aᵢⱼβⱼ≤bᵢ(i=1, 2 . . . , 6)

where

$$A = [ \begin{matrix}{x}_{1} & {y}_{1} & - 1 \\ {x}_{2} & {y}_{2} & - 1 \\ ⋮ & ⋮ & ⋮ \\ {x}_{6} & {y}_{6} & - 1\end{matrix} ]$$

$$b = {[ {x}_{1}^{2} + {y}_{1}^{2} , {x}_{2}^{2} + {y}_{2}^{2} , … , {x}_{6}^{2} + {y}_{6}^{2} ]}^{T}$$

$$β = {[ \begin{matrix}{β}_{1} & {β}_{2} & {β}_{3}\end{matrix} ]}^{T}$$

$${β}_{1} = 2 {x}_{0}$$

$${β}_{2} = 2 {y}_{0}$$

$${β}_{3} = {x}_{0}^{2} + {y}_{0}^{2} - {r}^{2}$$

describing the aforesaid problem using the Lagrange multiplier method to obtain:

$$L ( {β}_{i} , {λ}_{i} ) = \frac{1}{2} {‖ A \cdot β - b ‖}^{2} + {\sum }_{i = 1}^{6} {λ}_{i} ( {A}_{ij} {β}_{j} - {b}_{i} )$$

wherein, λ is the Lagrange multiplier, and λ≥0;

solving partial derivatives of βᵢ, λᵢ, which is as follows:

$$\frac{\partial L}{\partial {β}_{i}} = {\sum }_{j = 1}^{3} {( {A}^{T} A )}_{ij} {β}_{j} - {( {A}^{T} b )}_{i} + {\sum }_{j = 1}^{3} {λ}_{j} {A}_{ji} = 0$$

$$\frac{\partial L}{\partial {λ}_{i}} = {A}_{ij} {β}_{j} - {b}_{i} = 0$$

Since λ≥0, bᵢ≥Aᵢⱼβⱼ, thus, when

$${λ}_{i} \frac{\partial L}{\partial {λ}_{i}} = {λ}_{i} ( {A}_{ij} {β}_{j} - {b}_{i} ) = 0 ,$$

it is only possible that λᵢ=0 or Aᵢⱼβⱼ−bᵢ=0; for example, when λ₁>0, b₁≥A₁ⱼβⱼ, (x₁, y₁) needs to be located on the circle which is obtained by fitting according to the least squares objective function. Thus, when λᵢ>0, the pad of coordinates (xᵢ, yᵢ) is located on the circle which is obtained by fitting according to the least squares objective function.

A linear system of

$$[ \begin{matrix}{A}^{T} A & {\tilde{A}}^{T} \\ \tilde{A} & 0\end{matrix} ] \cdot [ \begin{matrix}β \\ \tilde{λ}\end{matrix} ] = [ \begin{matrix}{A}^{T} b \\ \tilde{b}\end{matrix} ]$$

will be generated under the constraint condition

$$of \frac{\partial L}{\partial {β}_{i}} = {\sum }_{j = 1}^{3} {( {A}^{T} A )}_{ij} {β}_{j} - {( {A}^{T} b )}_{i} + {\sum }_{j = 1}^{3} {λ}_{j} {A}_{ji} = 0 and$$

$${λ}_{i} \frac{\partial L}{\partial {λ}_{i}} = {λ}_{i} ( {A}_{ij} {β}_{j} - {b}_{i} ) = 0.$$

Wherein \tilde{λ} is a vector quantity which includes all non-zero λ, Ã and \tilde{b} are respectively subsets of A and b, their rows correspond to the nonzero λᵢ entries.

This problem can be further simplified based on characteristics of a circle, a condition of existence of two non-zero λᵢ and a condition of existence of three non-zero λᵢ are considered merely. Due to the fact that three points which are not collinear can solely determine a circle on the same plane, thus, when there exists three non-zero λᵢ, the circle can be solely determined. When there are more than three non-zero λᵢ, there are two corresponding conditions: 1) there is no solution that complies with the constraint condition; 2) there exists one solution and the circle can be determined by any three λᵢ.

Particularly, when there exist two λᵢ larger than 0, following formulas can be obtained according to

$$[ \begin{matrix}{A}^{T} A & {\tilde{A}}^{T} \\ \tilde{A} & 0\end{matrix} ] \cdot [ \begin{matrix}β \\ \tilde{λ}\end{matrix} ] = [ \begin{matrix}{A}^{T} b \\ \tilde{b}\end{matrix} ] :$$

$${β}_{1} = \frac{{\sum }_{{i = 1}_{i \neq {i}_{1} , {i}_{2}}}^{6} \{ \begin{matrix}[ ( {x}_{i} - {x}_{{i}_{1}} ) ( {y}_{{i}_{2}} - {y}_{{i}_{1}} ) - ( {x}_{{i}_{2}} - {x}_{{i}_{1}} ) ( {y}_{i} - {y}_{{i}_{1}} ) ] \cdot \\ [ ( {y}_{{i}_{2}} - {y}_{{i}_{1}} ) ( {b}_{i} - {b}_{{i}_{1}} ) - ( {y}_{i} - {y}_{{i}_{1}} ) ( {b}_{{i}_{2}} - {b}_{{i}_{1}} ) ]\end{matrix} \}}{{\sum }_{{i = 1}_{i \neq {i}_{1} , {i}_{2}}}^{6} {[ ( {x}_{i} - {x}_{{i}_{1}} ) ( {y}_{{i}_{2}} - {y}_{{i}_{1}} ) - ( {x}_{{i}_{2}} - {x}_{{i}_{1}} ) ( {y}_{i} - {y}_{{i}_{1}} ) ]}^{2}}$$

$${β}_{2} = \frac{{\sum }_{{i = 1}_{i \neq {i}_{1} , {i}_{2}}}^{6} \{ \begin{matrix}[ ( {x}_{{i}_{2}} - {x}_{{i}_{1}} ) ( {y}_{i} - {y}_{{i}_{1}} ) - ( {x}_{i} - {x}_{{i}_{1}} ) ( {y}_{{i}_{2}} - {y}_{{i}_{1}} ) ] \cdot \\ [ ( {x}_{{i}_{2}} - {x}_{{i}_{1}} ) ( {b}_{i} - {b}_{{i}_{1}} ) - ( {x}_{i} - {x}_{{i}_{1}} ) ( {b}_{{i}_{2}} - {b}_{{i}_{1}} ) ]\end{matrix} \}}{{\sum }_{{i = 1}_{i \neq {i}_{1} , {i}_{2}}}^{6} {[ ( {x}_{{i}_{2}} - {x}_{{i}_{1}} ) ( {y}_{i} - {y}_{{i}_{1}} ) - ( {x}_{i} - {x}_{{i}_{1}} ) ( {y}_{{i}_{2}} - {y}_{{i}_{1}} ) ]}^{2}}$$

$${β}_{3} = {β}_{1} {x}_{{i}_{1}} + {β}_{2} {y}_{{i}_{1}} - {b}_{{i}_{1}}$$

wherein, (xᵢ_{₁}, yᵢ_{₁}) and (xᵢ_{₂}, yᵢ_{₂}) are the two points that satisfy the constraint condition:

$$\frac{\partial L}{\partial {λ}_{i}} = {A}_{ij} {β}_{j} - {b}_{i} = 0.$$

When there exist three λᵢ larger than zero, three points (xᵢ₁, yᵢ₁), (xᵢ₂, yᵢ₂) and (xᵢ₃, yᵢ₃) that satisfy the constraint condition of

$$\frac{\partial L}{\partial {λ}_{i}} = {A}_{ij} {β}_{j} - {b}_{i} = 0$$

can be used to obtain β, wherein β includes:

$${β}_{1} = \frac{( {y}_{{i}_{2}} - {y}_{{i}_{3}} ) ( {b}_{{i}_{1}} - {b}_{{i}_{2}} ) - ( {y}_{{i}_{1}} - {y}_{{i}_{2}} ) ( {b}_{{i}_{2}} - {b}_{{i}_{3}} )}{( {x}_{{i}_{1}} - {x}_{{i}_{2}} ) ( {y}_{{i}_{2}} - {y}_{{i}_{3}} ) - ( {x}_{{i}_{2}} - {x}_{{i}_{3}} ) ( {y}_{{i}_{1}} - {y}_{{i}_{2}} )}$$

$${β}_{2} = \frac{( {x}_{{i}_{2}} - {x}_{{i}_{3}} ) ( {b}_{{i}_{1}} - {b}_{{i}_{2}} ) - ( {x}_{{i}_{1}} - {x}_{{i}_{2}} ) ( {b}_{{i}_{2}} - {b}_{{i}_{3}} )}{( {x}_{{i}_{2}} - {x}_{{i}_{3}} ) ( {y}_{{i}_{1}} - {y}_{{i}_{2}} ) - ( {x}_{{i}_{1}} - {x}_{{i}_{2}} ) ( {y}_{{i}_{2}} - {y}_{{i}_{3}} )}$$

$${β}_{3} = {β}_{1} {x}_{{i}_{1}} + {β}_{2} {y}_{{i}_{1}} - {b}_{{i}_{1}}$$

What described above illustrate a process of solving an optimal solution of ∥A·β−b∥² under the constraint condition of Aᵢⱼβⱼ≤bᵢ, (i=1, 2, . . . , 6) which also illustrate a detailed calculation process of solving, under the constraint condition of (xᵢ−x₀)²+(yᵢ−y₀)²≥r², the borehole center coordinates (x₀, y₀) and the borehole radius r when

$${\sum }_{i = 1}^{N} {\vert {( {x}_{i} - {x}_{0} )}^{2} + {( {y}_{i} - {y}_{0} )}^{2} - {r}^{2} \vert}^{2}$$

takes the minimal value is satisfied.

In step 103, correcting the coordinates of caliper pads by taking the borehole center as a reference point, obtaining the borehole cross-sectional shape at the depth of the well.

In particular, since the pad coordinates are obtained by the multi-arm caliper at the same depth of well in step 101, and it takes the multi-arm caliper center A as the reference point; since the multi-arm caliper center A may deviate from the borehole center, however, in step 102, the actual borehole center coordinates and the borehole radius at the depth of the well have been obtained according to the least squares objective function with the constraint condition. Thus, in order to obtain the actual cross-sectional shape of the borehole, the pad coordinates need to be corrected to the ones which take the borehole center as the reference point.

For example, FIG. 3 illustrates a comparison between a fitted result of a borehole cross-sectional shape obtained by fitting according to the method for determining borehole cross-sectional shape provided by the embodiment of the present application and a fitted result of a borehole cross-sectional shape obtained by fitting according to the method for determining borehole cross-sectional shape in related art.

Particularly, column 1 illustrates 10 groups of pad coordinates measured by six-arm caliper in the borehole which has predetermined borehole cross-sectional shape, and under the condition of random distribution of caliper center A, which is shown as “+” in FIG. 3. Column 2 illustrates a schematic view of a comparison between a fitted result of the borehole cross-sectional shape which is obtained according to the pad coordinates and by processing the pad coordinates using the method for determining borehole cross-sectional shape in the present application, and the actual borehole cross-sectional shape, “+” which is shown in FIG. 3 represents the fitted result; wherein, a continuous closed line represents a predetermined actual borehole cross-sectional shape. Column 3 illustrates a schematic view of a comparison between a fitted result of borehole cross-sectional shape obtained according to the pad coordinates and by processing the pad coordinates using the intersecting chord theorem, and the actual borehole cross-sectional shape, “+” which is shown in FIG. 3 represents the fitted result; wherein the continuous closed line represents the predetermined actual borehole cross-sectional shape. Column 4 illustrates a schematic view of a comparison between a fitted result of borehole cross-sectional shape obtained according to the pad coordinates and by performing an ellipse fitting for the pad coordinates, and the actual borehole cross-sectional shape, “+” which is shown in FIG. 3 represents the fitted result; wherein the continuous closed line represents the predetermined actual borehole cross-sectional shape. It needs to be explained that, it can be seen from the continuous closed lines shown in FIG. 3 that, columns 1-3 in FIG. 3 represent, under a condition of different degrees of breakouts, a schematic view of a comparison between the borehole cross-sectional shape obtained by fitting according to the method for determining borehole cross-sectional shape in the present application and the actual borehole cross-sectional shape, and a schematic view of a comparison between the borehole cross-sectional shape obtained according to the intersecting chord theorem and by performing the ellipse fitting in related art, and the actual borehole cross-sectional shape.

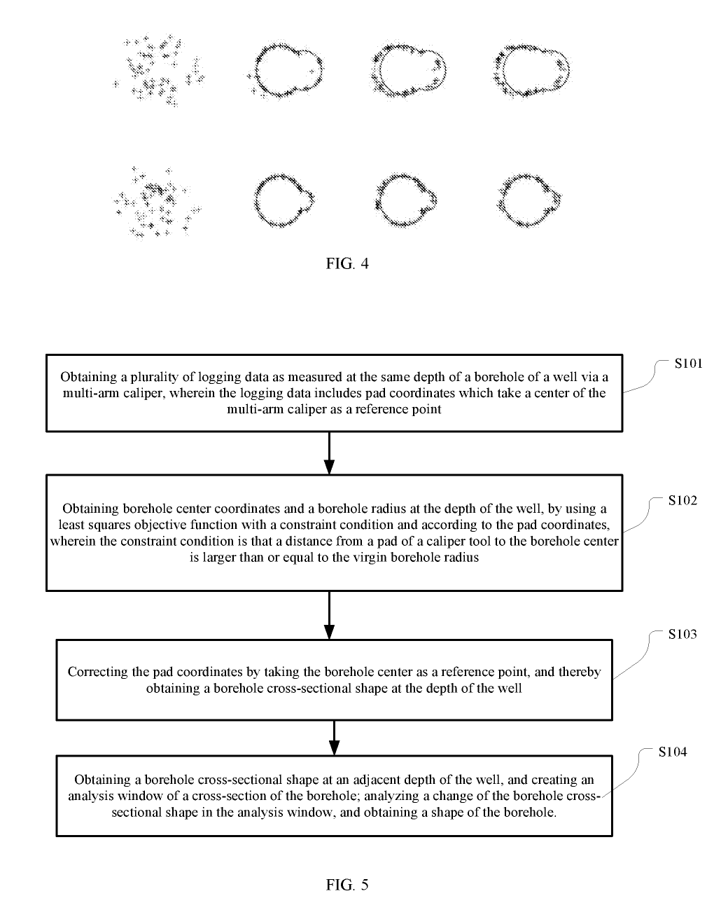

FIG. 4 illustrates another schematic view of a comparison between a fitted result of borehole cross-sectional shape obtained by fitting according to the method for determining borehole cross-sectional shape provided by the embodiment of the present application, and a fitted result of borehole cross-sectional shape obtained by fitting according to the method for determining borehole cross-sectional shape in related art.

Particularly, column 1 illustrates 10 groups of borehole coordinates measured by six-arm caliper in the borehole which has predetermined borehole cross-sectional shape, and under the condition of random distribution of caliper center A, which is shown as “+” in FIG. 3. Column 2 illustrates a schematic view of a comparison between a fitted result of the borehole cross-sectional shape which is obtained according to the pad coordinates and by processing the pad coordinates using the method for determining borehole cross-sectional shape in the present application, and the actual borehole cross-sectional shape, “+” which is shown in FIG. 3 represents the fitted result; wherein, a continuous closed line represents a predetermined actual borehole cross-sectional shape. Column 3 illustrates a schematic view of a comparison between a fitted result of borehole cross-sectional shape obtained according to the pad coordinates and by processing the pad coordinates using the intersecting chord theorem, and the actual borehole cross-sectional shape, “+” which is shown in FIG. 3 represents the fitted result; wherein the continuous closed line represents the predetermined actual borehole cross-sectional shape. Column 4 illustrates a schematic view of a comparison between a fitted result of borehole cross-sectional shape obtained according to the pad coordinates and by performing an ellipse fitting for the pad coordinates, and the actual borehole cross-sectional shape, “+” which is shown in FIG. 3 represents the fitted result; wherein the continuous closed line represents the predetermined actual borehole cross-sectional shape. It needs to be explained that, it can be seen from the continuous closed lines shown in FIG. 3 that, columns 1-3 in FIG. 3 represent, under a condition of different shapes and sizes of keyseats, a schematic view of a comparison between the borehole cross-sectional shape obtained by fitting according to the method for determining borehole cross-sectional shape in the present application and the actual borehole cross-sectional shape, and a schematic view of a comparison between the borehole cross-sectional shape obtained according to the intersecting chord theorem and by performing the ellipse fitting in related art, and the actual borehole cross-sectional shape.

It can be seen from the comparison results shown in FIG. 3 and FIG. 4 that, the method for determining borehole cross-sectional shape in the present application can still fit actual positions of sampling points of the various measuring arms very well when there exist keyseats or breakouts in the borehole, doesn't have a systematic deviation, and is advantageous over the intersecting chord theorem method and the ellipse fitting method in related art in aspects of application scope, stability of measuring result, and reliability.

Particularly, since the keyseats are usually generated at one side, and are caused mainly by drill pipe wear during well drilling; however, the breakouts are usually caused by reasons of, such as borehole stress concentration; thus, the breakouts are usually distributed symmetrically. Since the method for determining borehole cross-sectional shape according to the intersecting chord theorem and the ellipse fitting in related art doesn't have said constraint condition, for this reason, the method for determining borehole cross-sectional shape in related art can't identify conditions of breakouts and keyseats effectively, especially, a condition of a big keyseat is prone to be judged as a breakout, such that the borehole center and the borehole radius are calculated wrongly. However, the present application ensures that the pad coordinates can be located outside or on the circle which is obtained by fitting according to the least squares objective function by introducing the constraint condition, in this way, the actual borehole cross-sectional shape can be obtained, the actual shape of borehole can be further obtained, and a problem that accurate borehole shape can't be obtained due to distinct irregularity of the borehole cross-sectional shape which are caused by such as keyseats, breakouts can be avoided, various complex shapes of borehole can be processed effectively.

It needs to be noted that, since when the borehole shape is fitted by the least squares objective function with constraint condition in the embodiment of the present application, the solved borehole center coordinates and the borehole radius are optimal solution which have least conceptual data error, such that the method for determining borehole cross-sectional shape in this embodiment of the present application can have an inhibiting effect on error of data measured by few measuring arms of the multi-arm caliper; in other words, this method is insensitive to the error of data measured by the various measuring arms of the multi-arm caliper, and has great data redundancy. Simultaneously, when the caliper center deviates from the borehole center, the caliper can still obtain the borehole center coordinates and the borehole radius accurately.

For example, when there exist breakouts or keyseats in the borehole, the caliper center may deviate from the borehole center and fall within the breakouts or the keyseats, then, the plurality of measuring arms of the multi-arm caliper may get stuck in the breakouts or the keyseats, there is only a few measuring arms that can perform sampling for a protogenic wellbore wall effectively, however, the present application can calculate the actual borehole center and borehole radius only by virtue of more than two effective sampling data points of the protogenic wellbore wall, and thus is insensitive to deviation of the caliper center from the borehole center, and can still obtain the borehole center coordinates and the borehole radius accurately when the caliper center deviates from the borehole center.

As shown in FIG. 5, in some embodiments of the present application, after correcting the pad coordinates by taking the borehole center as the reference point, and obtaining the borehole cross-sectional shape at the depth of the well, the method further comprises: step 104, obtaining borehole cross-sectional shape at an adjacent depth of the well, creating an analysis window of a borehole cross-section, analyzing a change of the borehole cross-sectional shape in the analysis window, and obtaining the shape of the borehole.

In particular, firstly, the borehole center coordinates (x₀, y₀) obtained in the step S102 are used to correct the pad coordinates (xᵢ, yᵢ) so as to obtain the fixed wellbore wall coordinates and obtain the borehole cross-sectional shape at the depth of the well. Wherein the pad coordinates (xᵢ, yᵢ) are referred to as the pad coordinates (xᵢ, yᵢ), which are measured by the multi-arm caliper in step S101 and take the multi-arm caliper center A as the reference point.

Then, borehole cross-sectional shapes at the adjacent depths of the well are grouped into the analysis window of the borehole cross-section; wherein, the borehole cross-sectional shapes at the adjacent depths of the well are referred to as taking the borehole cross-sectional shape measured at a certain depth of the well as a basis, grouping the borehole cross-sectional shapes measured at an upper side and a lower side of the depth of the well into the analysis window. It needs to be noted that, in some implementation modes of the present application, a caliper logging is performed in the well according to a preset spacing distance; for example, the preset spacing distance can be 10 cm, 20 cm and so on, said grouping the borehole cross-sectional shapes at the adjacent depths of the well into the analysis window of the borehole cross-section is referred to as taking the borehole cross-sectional shape measured at a certain depth of well as the basis, grouping the borehole cross-sectional shapes at a depth which is spaced from the depth of the well upper and lower, with a spacing of 10 cm, 20 cm . . . etc., into the analysis window. And then, the change of the borehole cross-sectional shape within the analysis window is analyzed, and the shape of the borehole is obtained.

Subsequently, a change of the borehole cross-sectional shape within the analysis window is analyzed, and the shape of the borehole is obtained.

After the aforesaid borehole cross-sectional shape is obtained, the change of the borehole cross-sectional shape within the analysis window is analyzed, the borehole cross-section state at the depth of the well is obtained, such that the overall shape of the borehole can be obtained.

For example, the borehole cross-section state includes whether the borehole cross-section is an intact borehole cross-section, or whether there exist breakouts, keyseats, washout; and data such as widths, directions and depths of breakouts, sizes, positions, directions and depths of keyseats, range and extent of washout, and an area of the borehole cross-section are calculated, the borehole cross-section state at the depth of the well is obtained, so that the overall shape of the borehole is obtained.

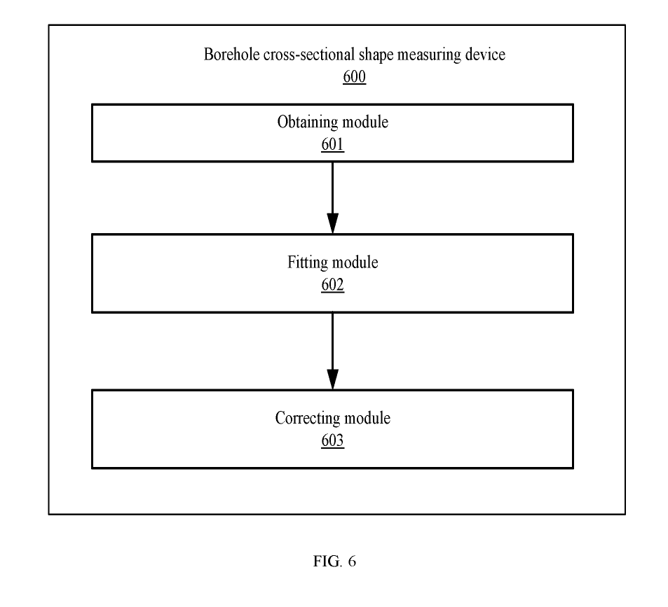

FIG. 6 illustrates a structural schematic view of a device 600 for measuring borehole cross-sectional shape, comprising:

an obtaining module 601 configured to obtain a plurality of logging data as measured at a same depth of a well via by a multi-arm caliper, wherein the logging data includes pad coordinates which take a center of the multi-arm caliper as a reference point;

a fitting module 602 configured to obtain borehole center coordinates and a borehole radius at the depth of the well by using a least squares objective function with a constraint condition and according to the pad coordinates; wherein the constraint condition is that a distance from a pad of a caliper tool to the borehole center is larger than or equal to the virgin borehole radius; and

a correcting module 603 configured to correct the pad coordinates by taking the borehole center as a reference point, and thereby to obtain a borehole cross-sectional shape at the depth of the well.

Furthermore, the least squares objective function is a sum of 2-norm of a difference between a square of the distance from the pad coordinates to the borehole center coordinates, and a square of the borehole radius.

Furthermore, the fitting module 602 is particularly configured to solve, under a constraint of the constraint condition, the borehole center coordinates and the borehole radius when the least squares objective function takes a minimal value.

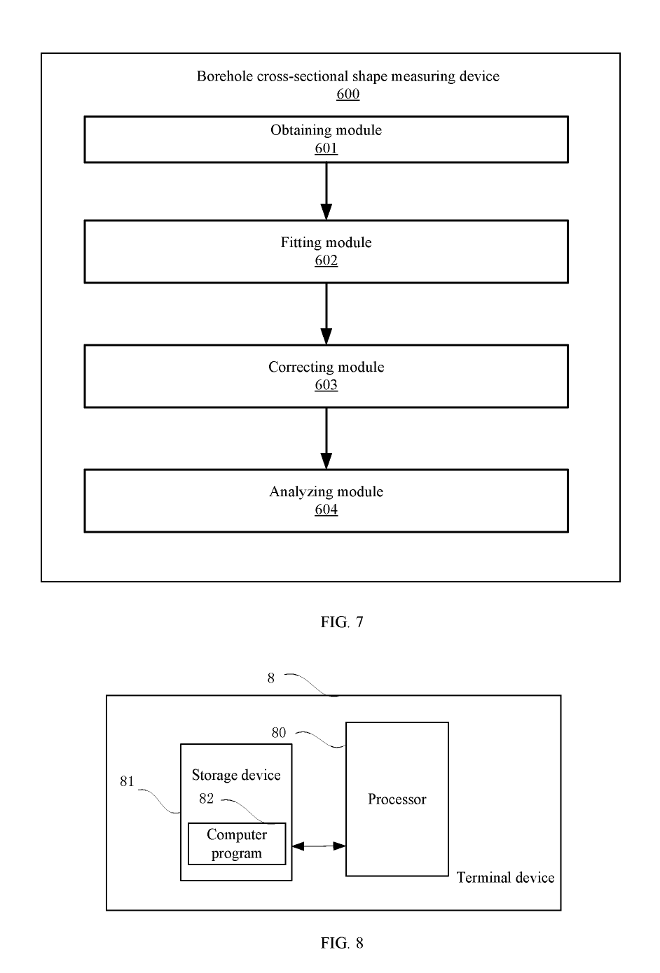

Furthermore, FIG. 7 illustrates another structural schematic view of a device for determining borehole cross-sectional shape provided by one embodiment of the present application, except for comprising the obtaining module 601, the fitting module 602 and the correcting module 603, the device further comprises an analyzing module 604 configured to obtain a borehole cross-sectional shape at an adjacent depth of the well, create an analysis window of a cross-section of the borehole, and analyze a change of the borehole cross-sectional shape within the analysis window, and obtain a shape of the borehole.

It needs to be noted that, for describing more conveniently and concisely, regarding the detailed working process of the device for determining borehole cross-sectional shape described above, please refer to a corresponding process of the method illustrated in FIG. 1, it is not repeatedly described herein.

FIG. 8 illustrates a schematic view of measuring device provided by one embodiment of the present application. As shown in FIG. 8, the measuring device 8 in this embodiment comprises: a processor 80, a storage device 81 and computer program 82 stored in the storage device 81 and executable by the processor 80, such as borehole cross-sectional shape determining procedure. The processor implements steps in the embodiments of various methods for determining borehole cross-sectional shape when executing the computer program 82, such as steps from step 101 to step 103 shown in FIG. 1; as an alternative, the processor 80 implements the functionalities of the various modules/units in the various device embodiments when executing the computer program 82, such as the functionalities of modules 601-603 shown in FIG. 6.

Exemplarily, the computer procedure 10 can be divided into one or a plurality of modules/units, the one or plurality of modules/units are stored in the storage device 81, and executed by the processor 80 so as to implement the present application. The one or plurality of modules/units can be a series of computer program instruction segments that can accomplish particular functionalities, these instruction segments are used for describing an executive process of the computer program 82 in the measuring terminal 8. The measuring terminal 8 can be a computing device such as the caliper, the cloud server, etc. The terminal device for determining borehole cross-sectional shape can include but is not limited to: the processor 80, the storage device 81. It can be understood for one of ordinary skill in the art that, FIG. 8 is merely an example of the measuring terminal 8, and is not constituted as limitation to the measuring terminal 8, more or less components shown in FIG. 8 can be included, or some components or different components can be combined; for example, the terminal device for determining borehole cross-sectional shape can also include an input and output device, a network access device, a bus, etc.

The so called processor 80 can be CPU (Central Processing Unit), and can also be other general purpose processor, DSP (Digital Signal Processor), ASIC (Application Specific Integrated Circuit), FGPA (Field-Programmable Gate Array), or some other programmable logic devices, discrete gate or transistor logic device, discrete hardware component, etc. The general purpose processor can be a microprocessor, or alternatively, the processor can also be any conventional processor and so on.

The storage device 81 can be an internal storage unit of the measuring device 10, such as a hard disk or a memory of the measuring device 10. The storage device 81 can also be an external storage device of the measuring device 10, such as a plug-in hard disk, a SMC (Smart Media Card), a SD (Secure Digital) card, a FC (Flash Card) equipped on the measuring device 10. Further, the storage device 81 may include both the internal storage unit and the external storage device of the measuring device 10, either. The storage device 81 is configured to store the computer programs, and other procedures and data needed by the measuring device 10 for determining borehole cross-sectional shape. The storage device 81 can also be configured to storing data that has been output or being ready to be output temporarily.

It can be clearly understood by the one of ordinary skill in the art that, for describing conveniently and concisely, dividing of the aforesaid various functional units, functional modules is described exemplarily merely, in an actual application, the aforesaid functions can be assigned to different functional units and functional modules to be accomplished, that is, an inner structure of a data synchronizing device is divided into functional units or modules so as to accomplish the whole or a part of functionalities described above. The various functional units, modules in the embodiments can be integrated into a processing unit, or each of the units exists independently and physically, or two or more than two of the units are integrated into a single unit. The aforesaid integrated unit can by either actualized in the form of hardware or in the form of software functional units. In addition, specific names of the various functional units and modules are only used for distinguishing from each other conveniently, but not intended to limit the protection scope of the present application. Regarding a specific working process of the units and modules in the aforesaid device, please refer to a corresponding process in the aforesaid method embodiments, it is not repeatedly described herein.

In the aforesaid embodiments, the description of each of the embodiments is emphasized respectively, regarding a part of one embodiment which isn't described or disclosed in detail, please refer to relevant descriptions in some other embodiments.

One of ordinary skill in the art will notice that, the elements and algorithm steps of each of the examples described in connection with the embodiments disclosed herein can be implemented in electronic hardware, or in combination with computer software and electronic hardware. Whether these functions are implemented by hardware or software depends on the specific application and design constraints of the technical solution. The skilled people could use different methods to implement the described functions for each particular application, but such implementations should not be considered as going beyond the scope of the present application.

It should be understood that, in the embodiments of the present application, the disclosed device/terminal device and method could be implemented in other ways. For example, the device described above are merely illustrative; for example, the division of the units is only a logical function division, and other division could be used in the actual implementation, for example, multiple units or components could be combined or integrated into another system, or some features can be ignored, or not performed. In another aspect, the coupling or direct coupling or communicating connection shown or discussed could be an indirect, or a communicating connection through some interfaces, devices or units, which could be electrical, mechanical, or otherwise.

The units described as separate components could or could not be physically separate, the components shown as units could or could not be physical units, which can be located in one place, or can be distributed to multiple network elements. Parts or all of the elements could be selected according to the actual needs to achieve the object of the present embodiment.

In addition, the various functional units in each of the embodiments of the present application can be integrated into a single processing unit, or exist individually and physically, or two or more than two units are integrated into a single unit. The aforesaid integrated unit can either be achieved by hardware, or be achieved in the form of software functional units.

If the integrated unit is achieved in the form of software functional units, and is sold or used as an independent product, it can be stored in a computer readable storage medium. Based on this understanding, a whole or part of flow process of implementing the method in the aforesaid embodiments of the present application can also be accomplished by the computer programs configured to instruct relevant hardware. When the computer program is executed by the processor, the steps in the various method embodiments described above can be implemented. Wherein, the computer program comprises computer program codes, which can be in the form of source code, object code, executable documents or some intermediate form, etc. The computer readable medium can include: any entity or device that can carry the computer program codes, recording medium, USB flash disk, mobile hard disk, hard disk, optical disk, computer storage device, ROM (Read-Only Memory), RAM (Random Access Memory), electrical carrier signal, telecommunication signal and software distribution medium, etc. It needs to be explained that, the contents contained in the computer readable medium can be added or reduced appropriately according to the requirement of legislation and patent practice in a judicial district, for example, in some judicial districts, according to legislation and patent practice, the computer readable medium doesn't include electrical carrier signal and telecommunication signal.

As stated above, the aforesaid embodiments are only intended to explain but not to limit the technical solutions of the present application. Although the present application has been explained in detail with reference to the above-described embodiments, it should be understood for the one of ordinary skill in the art that, the technical solutions described in each of the above-described embodiments can still be amended, or some technical features in the technical solutions can be replaced equivalently; these amendments or equivalent replacements, which won't make the essential of corresponding technical solution to be broken away from the spirit and the scope of the technical solution in various embodiments of the present application, should all be included in the protection scope of the present application.

What is claimed is:

1. A method for determining a cross-sectional shape of a borehole of a well, comprising:
obtaining a plurality of logging data items measured at a same depth of the well via a multi-arm caliper, wherein the logging data items include pad coordinates of each pad of the caliper using a center of the multi-arm caliper as a reference point;
obtaining coordinates of a borehole center and a borehole radius at the depth of the well, by using a least squares objective function with a constraint condition and according to the pad coordinates, wherein the constraint condition is that a distance from a pad of the multi-arm caliper to the borehole center is larger than or equal to the borehole radius; and
correcting the pad coordinates by using the borehole center as a reference point, and thereby obtaining the cross-sectional shape of the borehole at the depth of the well.

2. The method according to claim 1, wherein:
the least squares objective function is a sum of 2-norm of a difference between a square of the distance from the pad coordinates to the borehole center coordinates and a square of the borehole radius.

3. The method according to claim 1, wherein the obtaining coordinates of a borehole center and a borehole radius at the depth of the well, by using a least squares objective function with a constraint condition comprises:
solving, under constraint of the constraint condition, the borehole center coordinates and the borehole radius when the least squares objective function takes a minimal value.

4. The method according to claim 1, wherein after correcting the pad coordinates by using the borehole center as a reference point and obtaining the cross-sectional shape of the borehole of the well, the method further comprises:
obtaining a cross-sectional shape of the borehole at an adjacent depth of the well, and creating an analysis window of a cross-section of the borehole; and
analyzing a change of the cross-sectional shape of the borehole in the analysis window, and obtaining a shape of the borehole.

5. A device for determining a cross-sectional shape of a borehole of a well, comprising:
an obtaining module configured to obtain a plurality of logging data items measured at a same depth of a well via by a multi-arm caliper, wherein the logging data items include pad coordinates of each pad of the caliper which uses a center of the multi-arm caliper as a reference point;
a fitting module configured to obtain borehole center coordinates and a borehole radius at the depth of the well by using a least squares objective function with a constraint condition and according to the pad coordinates; wherein the constraint condition is that a distance from a pad of the multi-arm caliper to the borehole center is larger than or equal to the borehole radius; and
a correcting module configured to correct the pad coordinates by using the borehole center as a reference point, and thereby to obtain the cross-sectional shape of the borehole at the depth of the well.

6. The device according to claim 5, wherein the least squares objective function is a sum of 2-norm of a difference between a square of the distance from the pad coordinates to the borehole center coordinates and a square of the borehole radius.

7. The device according to claim 5, wherein the fitting module is particularly configured to:
solve, under constraint of the constraint condition, the borehole center coordinates and the borehole radius when the least squares objective function takes a minimal value.

8. The device according to claim 5, wherein the device further comprises:
an analyzing module configured to obtain a cross-sectional shape of the borehole at an adjacent depth of the well, create an analysis window of a cross-section of the borehole, analyze a change of the cross-sectional shape of the borehole in the analysis window, and obtain a shape of the borehole.

9. A measuring terminal comprising a storage device, a processor and computer program stored in the storage device, and executable by the processor, wherein the processor is configured to implement steps in claim 1 when executing the computer program.

10. A computer readable storage medium which stores computer program, wherein steps in claim 1 are implemented when the computer program is executed by a processor.

11. The measuring terminal of claim 9, wherein the least squares objective function is a sum of 2-norm of a difference between a square of the distance from the pad coordinates to the borehole center coordinates and a square of the borehole radius.

12. The measuring terminal of claim 9, wherein the using a least squares objective function with a constraint condition to obtain borehole center coordinates and a borehole radius at the depth of the well comprises:
solving, under constraint of the constraint condition, the borehole center coordinates and the borehole radius when the least squares objective function takes a minimal value.

13. The measuring terminal of claim 9, wherein the processor is further configured to:
obtain a cross-sectional shape of the borehole at an adjacent depth of the well, and create an analysis window of a cross-section of the borehole; and
analyze a change of the cross-sectional shape of the borehole in the analysis window, and obtain a shape of the borehole.

14. The computer readable storage medium of claim 10, wherein the least squares objective function is a sum of 2-norm of a difference between a square of the distance from the pad coordinates to the borehole center coordinates and a square of the borehole radius.

15. The computer readable storage medium of claim 10, wherein the using a least squares objective function with a constraint condition to obtain borehole center coordinates and a borehole radius at the depth of the well comprises:
solving, under constraint of the constraint condition, the borehole center coordinates and the borehole radius when the least squares objective function takes a minimal value.

16. The computer readable storage medium of claim 10, wherein the computer program, when executed by the processor, further causes the processor to:
obtain a cross-sectional shape of the borehole at an adjacent depth of the well, and create an analysis window of a cross-section of the borehole; and
analyze a change of the cross-sectional shape of the borehole in the analysis window, and obtain a shape of the borehole.

17. A system for determining a cross-sectional shape of a borehole of a well, the system comprising a processing arrangement including at least one processor, the processor being configured to perform:
obtaining a plurality of logging data items measured at a same depth of a well via by a multi-arm caliper having a center and plural pads, wherein the logging data items include pad coordinates of each pad of the caliper which uses the center of the multi-arm caliper as a reference point;
obtaining borehole center coordinates and a borehole radius at the depth of the well via by using a least squares objective function with a constraint condition and according to the pad coordinates; wherein the constraint condition comprises that a distance from a pad of the multi-arm caliper to the borehole center is larger than or equal to the borehole radius; and
correcting the pad coordinates by using the borehole center as a reference point, thereby obtaining the cross-sectional shape of the borehole at the depth of the well via.

18. The system of claim 17 wherein the processor is further configured to perform the least squares objective function comprising a sum of 2-norm of a difference between a square of the distance from the wellbore wall pad coordinates to the borehole center coordinates and a square of the borehole radius.

19. The system of claim 17 wherein the processor is further configured to solve, under constraint of the constraint condition, the borehole center coordinates and the borehole radius when the least squares objective function takes a minimal value.
